(19) United States
(12) Patent Application Publication
(10) Pub. No.: US 2006/0113730 A1
(43) Pub. Date: Jun. 1, 2006

(54) Combination oil ring

(76) Inventors: Takao Suzuki, Aichi (JP); Kazuhito Seki, Saitama (JP); Shiro Shibata, Saitama (JP); Nobuyuki Matsushima, Tochigi (JP)

Correspondence Address: LADAS & PARRY LLP, 224 SOUTH MICHIGAN AVENUE, SUITE 1600, CHICAGO, IL, 60604, US

(21) Appl. No.: 10/551,000

(22) PCT Filed: Apr. 6, 2004
(86) PCT No.: PCT/JP04/04952

§ 371 Date: Jan. 6, 2006

(30) Foreign Application Priority Data
Apr. 7, 2003 (JP) 2003-103350
Apr. 7, 2003 (JP) 2003-103497

(51) Int. Cl. F02F 5/00; B60T 11/236

(52) U.S. Cl. 277/434

(57) ABSTRACT

A main object of the present invention is to provide a combined oil ring capable of exhibiting a sufficient tension, having excellent oil scraping function and oil control function, even if a coil expander formed of a shape memory alloy is used. To achieve the above mentioned object, the present invention provides a combined oil ring comprising: an oil ring formed into cross-section substantially of an I-shape that two rails are connected at a columnar portion thereof; and a coil expander, which is placed in an inner peripheral groove formed on the inner side of a periphery of the columnar portion connecting the two rails of the oil ring, and which presses the oil ring radially outward, wherein the coil expander is formed of a shape memory alloy, and is formed of anomaly wire having rectangular cross sectional shape.

### TECHNICAL FIELD

The present invention relates to a combined oil ring used for a piston of an internal combustion engine.

### BACKGROUND ART

In an internal combustion engine, various friction losses are generated. By reducing such friction losses, fuel economy can be enhanced. For example, in a piston ring of the internal combustion engine, it is required to reduce the friction caused during sliding motion with respect to a cylinder liner. More specifically, in order to reduce the friction, it is effective to reduce the tension.

As the piston ring, there are a pressure ring and an oil ring. Especially the oil ring satisfies a function as the oil ring by increasing the tension (a force expanding the piston ring outward in a radial direction thereof) by 5 to 12 times of the pressure ring, i.e., a function of scraping off the oil and a function of controlling oil. For example, concerning a total tension ratio obtained by dividing a total ring tension, which is a sum of the tensions of the piston ring (pressure ring+oil ring), by a bore diameter, the total tension ratio is 0.6 to 1.0 N/mm in 1984, but since it is required to reduce the friction, the total tension ratio is gradually reduced, and the current total tension ratio is reduced as small as 0.2 to 0.6 N/mm, so that a countermeasure thereof is required.

Although this numeric value is about a half as compared with that of 1984, it is required to satisfy the function of the oil ring in such circumstances.

To satisfy the requirement of the piston ring, the contact area of the piston ring is reduced and a width thereof is reduced as the tension is reduced. As compared with the pressure ring, in order to provide an oil scraping function to the oil ring, by further reducing the contact width, the contact area is reduced and the surface pressure is increased. By this, a sealing function and the oil scraping function are improved.

However, if the tension of the oil ring is in the above range, i.e., if the tension is at the same level as that of a case the engine is sufficiently driven, at the start up of the engine, the effect of the oil ring is exhibited excessively, and there is a danger that the starting performance of the engine is deteriorated. This is because that the temperature of lubricant and the temperature of the engine are gradually increased at the start up of the engine, the temperatures of the lubricant and the engine are low, and viscosity of the lubricant is high, as compared with a case in which a certain time has passed since the start us of the engine and the engine is sufficiently driven. Therefore, during the time from the start up of the engine until the engine is sufficiently driven, it is desirable that the surface pressure increases, as the temperatures of the lubricant and the engine increase, so that the function is gradually exhibited.

For example, Japanese Utility Model Application Publication No. 3-41078 discloses a technique in which, in an oil ring using a coil expander formed of shape memory alloy of Ni—Ti based, the coil expander is treated such that it is brought into a contraction state at low temperature and into an stretched state at high temperature.

By forming the coil expander with the shape memory alloy, a force pressing the oil ring radially outward can be changed depending on the temperature. Therefore, the starting performance of the engine can be improved. However, the modulus of transverse elasticity of the shape memory alloy is about 5, 000 to 10,000 MPa in its contraction state and is about 20,000 MPa in its stretched state, in two dimensional system of Ni—Ti. This numerical value is about ¼ of that of a coil expander formed of steel wire. Thus, in order to obtain the same tension as that of usually used steel wire, it is necessary to increase the thickness of the wire formed of the shape memory alloy by 4 times of that of the steel wire. In contrast, in the current oil ring, there is a tendency that the width of the oil ring is reduced so as to improve the following capability, and it is difficult to put the coil expander formed of the shape memory alloy into practical use due to limitation in sizes.

Also, Japanese Utility Model Application Publication No. 7-43540 discloses a technique in which a coil expander is formed of the shape memory alloy of two dimensional system of Ni—Ti, but a problem to be solved by this technique is to remove carbon attached to a piston ring groove of a diesel engine, and the intension thereof is not to improve the function of the combined oil ring.

As an expander which is not formed of the shape memory alloy but which can exhibit sufficient tension and which can be used with a thin oil ring, Japanese Patent Application Laid-open No. 2001-208200 discloses a technique using an expander obtained by corrugating a plate material having rectangular cross sectional shape shape, in its thickness direction, and forming it into an annular shape. However, since the tension of the expander at the time of start up of the engine is the same as that of the engine sufficiently driven, this technique has a problem in the starting performance. If a rectangular shape memory alloy material is used and it is corrugated in its axial direction, since it is set to a jig when memory thermal treatment (treatment for the material to memorize the shape) in post-treatment, productivity is extremely inferior.

### DISCLOSURE OF THE INVENTION

The present invention has been accomplished in view of the above mentioned problems, and a main object of the present invention is to provide a combined oil ring capable of exhibiting a sufficient tension, and having excellent oil scraping function and oil control function, even if a coil expander formed of a shape memory alloy is used, and to provided a combined oil ring which can be used for a thin oil ring, having excellent following capability, the friction can be reduced and having good productivity.

To achieve the above mentioned object, the present invention provides, as a first embodiment, a combined oil ring comprising: an oil ring formed into cross-section substantially of an I-shape that two rails are connected at a columnar portion thereof; and a coil expander, which is placed in an inner peripheral groove formed on the inner side of a periphery of the columnar portion connecting the two rails of the oil ring, and which presses the oil ring radially outward, wherein the coil expander is formed of a shape memory alloy, and is formed of anomaly wire having rectangular cross sectional shape.

In the present invention, the coil expander is formed of a shape memory alloy and the anomaly wire having a rectangular cross sectional shape is used. As shown in FIG. 4, since it is difficult to manufacture the coil expander, whose ratio (coil diameter/wire material thickness=ratio) of the coil diameter (d7) and the wire material thickness (35) is in a range smaller than 2.8 to 3, when the coil expander is designed to have the same coil diameter and the tension, it is possible to reduce the wire material thickness (35) of the expander line if the anomaly wire is used, i.e., the above mentioned ratio can be increased as compared with a round shape, and this is advantageous in terms of manufacture ability. Therefore, since it can respond even to the thin oil ring whose size is limited, a combined oil ring having excellent oil scraping function and oil control function can be obtained. Since the shape memory alloy is used, even when the oil viscosity is high, when starting the engine, the friction can be reduced.

In the present invention, it is preferable that the coil expander formed of the shape memory alloy is treated such that if a temperature of the coil expander itself is higher than a martensitic transformation temperature of the shape memory alloy, the coil expander extends in its longitudinal direction. With such treatment, when a certain time has passed after the starting of the engine and the engine is sufficiently driven, the coil expander extends in its longitudinal direction if the temperature of the lubricating oil and the engine temperature rise and the temperature of the coil expander itself exceeds the martensitic transformation temperature. Therefore, the tension will be increased as compared with a case at the starting of the engine. With this, since the surface pressure of the oil ring is increased, sufficient function, for scraping off the excessive lubricating oil in the cylinder, can be obtained.

In the present invention, it is preferable that a ratio of a thickness and a width of the cross sectional shape of the anomaly wire, which forms the coil expander, is in a range of 1:1 to 1:4. If the anomaly wire has the ratio of the thickness and the width in the above range, when the anomaly wire is wound in a form of a coil at a predetermined pitch to form the coil expander, a predetermined tension can be obtained.

The present invention provides, as a second embodiment, a combined oil ring comprising: an oil ring formed into cross-section substantially of an I-shape that two rails are connected at a columnar portion thereof; and a coil expander, which is placed in an inner peripheral groove formed on the inner side of a periphery of the columnar portion connecting the two rails of the oil ring, and which presses the oil ring radially outward, wherein a width of the oil ring in an axial direction is in a range of 0.3 mm to 3 mm, the coil expander is formed of a shape memory alloy, and the coil expander is treated such that if a temperature of the coil expander itself is higher than a martensitic transformation temperature of the shape memory alloy, the coil expander extends in its longitudinal direction.

In the present invention, the combined oil ring comprises: a thin oil ring whose width is in the above mentioned range; and the coil expander formed of a treated shape memory alloy. Thus, the following capability can further be enhanced. Since the coil expander of the present invention is treated such that the coil expander extends in its longitudinal direction if the temperature of the coil expander itself exceeds the martensitic transformation temperature, when the engine is sufficiently driven, the tension exhibited by the coil expander can be increased as compared with a case at the starting of the engine. With this, the following capability of the oil ring can be enhanced. Thus, the combined oil ring can exhibit excellent following capability by the functions of both the thin oil ring and the coil expander formed of the shape memory alloy. Even when the oil viscosity is high at the starting of the engine, the friction can be reduced.

In the present invention, it is preferable that the width of the oil ring in the axial direction is in a range of 1.0 mm to 3.0 mm. If the oil ring has the width of the oil ring in the axial direction in the above mentioned range, the following capability is remarkably enhanced by the martensitic transformation of the coil expander, and the combined oil ring can exhibit further excellent following capability.

Further, in the present invention, it is preferable that the coil expander, which is formed of the shape memory alloy, is formed by using an anomaly wire. If the anomaly wire is wound into a form of a coil, desired tension can be obtained in a range in which the productivity of the coil expander is excellent.

In the present invention, it is preferable that a ratio of a thickness and a width of the cross sectional shape of the anomaly wire, which forms the coil expander, is in a range of 1:1 to 1:4. If the anomaly wire has the ratio of the thickness and the width in the above mentioned range, when the anomaly wire is wound into a form of a coil at a predetermined pitch to form the coil expander, a predetermined tension can be obtained.

According to the first embodiment, since the coil expander is formed of the shape memory alloy using the anomaly wire having the rectangular cross sectional shape, desired tension can be obtained without increasing the coil diameter of the coil expander. Therefore, since it can respond even to the thin oil ring, whose size is limited, a combined oil ring having excellent oil scraping function and oil control function can be obtained. Since the shape memory alloy is used, even when the oil viscosity at the time of starting of the engine is high, the friction can be reduced.

According to the second embodiment, the combined oil ring is obtained by combining: the oil ring having the width in the axial direction of the oil ring in the predetermined range; and the coil expander formed of the shape memory alloy, and is treated such that the coil expander extends in its longitudinal direction if a temperature of the coil expander itself is higher than a martensitic transformation temperature. Thus, the following capability can further be enhanced. Since the coil expander of the present invention is treated as described above, when the engine is sufficiently driven, the tension exhibited by the coil expander can be higher than a case at the starting of the engine. With this, the following capability of the oil ring can be enhanced. Thus, the combined oil ring can exhibit excellent following capability by the functions of both the thin oil ring and the coil expander formed of the shape memory alloy. Even when the oil viscosity is high at the starting of the engine, the friction can be reduced.

### BRIEF DESCRIPTION OF THE DRAWINGS

FIG. 1 is a schematic sectional view showing one example of a combined oil ring of the present invention;

FIG. 2 is an explanatory view explaining a coil expander of the present invention;

FIG. 3 is an explanatory view explaining the coil expander of the present invention;

FIG. 4 is an explanatory view explaining a difference between a round cross sectional shape and a rectangular cross sectional shape of a wire material forming the coil expander;

FIG. 5 is a schematic sectional view showing another example of the combined oil ring of the present invention;

FIG. 6 is a graph showing a result of research of tension variation of the coil expander before and after martensitic transformation;

FIG. 7 is a graph showing an amount which an oil ring can follow at room temperature and at high temperature;

FIG. 8 is a graph showing the relation between a variation amount of the amount which an oil ring can follow and a width of the oil ring in the axial direction at room temperature and at high temperature; and

FIG. 9 is a graph showing a variation in variable tension margin with respect to a transverse ratio in cross sectional shape of anomaly wire of the coil expander in an embodiment of the present invention.

### BEST MODE FOR CARRYING OUT THE INVENTION

Hereinafter, a combined oil ring of the present invention will be explained based on a first embodiment and a second embodiment.

### A. First Embodiment

First, a combined oil ring of the first embodiment will be explained.

The combined oil ring of this embodiment comprises: an oil ring formed into cross-section substantially of an I-shape that two rails are connected at a columnar portion thereof; and a coil expander, which is placed in an inner peripheral groove formed on the inner side of a periphery of the columnar portion connecting the two rails of the oil ring, and which presses the oil ring radially outward, wherein the coil expander is formed of a shape memory alloy, and is formed of anomaly wire having rectangular cross sectional shape.

In this embodiment, the coil expander is formed of shape memory alloy, and uses anomaly wire having a rectangular cross sectional shape. Therefore, sufficient tension can be obtained without increasing the diameter of the coil of the coil expander. This is because of the following reason.

FIG. 4 is an explanatory view of a cross sectional shape of the coil expander. For explanation, pitches (p) are aligned at a left end surface, and a circle wire and a rectangular wire are superposed on each other in FIG. 4. The inner diameter (d17) is set so as to secure the productivity (it is difficult to produce when a ratio of coil diameter (d7)/wire material thickness (35) is equal to or smaller than 2.8) and a space for connecting wire which is inserted into a coil inner periphery.

To match a thin ring, it is necessary to set the coil diameter (d7) small, but the coil diameter (d7) and the inner diameter (d17) are bounded as mentioned above. In the case of the circular wire, in a case of increasing the tension, it is necessary to set the circular wire size (d35) larger, and if the coil diameter (d7) is constant, it is necessary to set the inner diameter (d17) small. If the inner diameter (d17) is to be secured, the coil diameter (d7) is adversely increased. In contrast, in the case of the rectangular wire, a wire material width (32) can be set large with respect to the wire material thickness (35) without changing the coil diameter (d7) and the inner diameter (d17) and thus, a desired tension can be obtained even with the same pitch.

Therefore, in this embodiment, since the coil expander is formed of shape memory alloy, and uses the anomaly wire having the rectangular cross sectional shape, when the tension is set to the same value in the same coil diameter, because it is difficult to produce the coil expander in a region where the ratio of the coil diameter (d7) and the wire material thickness (35) (coil diameter/wire material thickness=ratio) is smaller than 2.8 to 3 as shown in FIG. 4, the wire material thickness (35) of the expander wire of the anomaly wire can be set small with respect to the circular shape, i.e., the above-described ratio can be increased, and this is advantageous in terms of manufacturability. The coil expander can match even the thin oil ring whose size is limited, and thus, a combined oil ring having excellent oil scraping function and oil control function can be obtained. Since the shape memory alloy is used, even when the oil viscosity is high at starting of the engine, the friction can be reduced.

The combined oil ring of the embodiment having such merits will be explained specifically using the drawings.

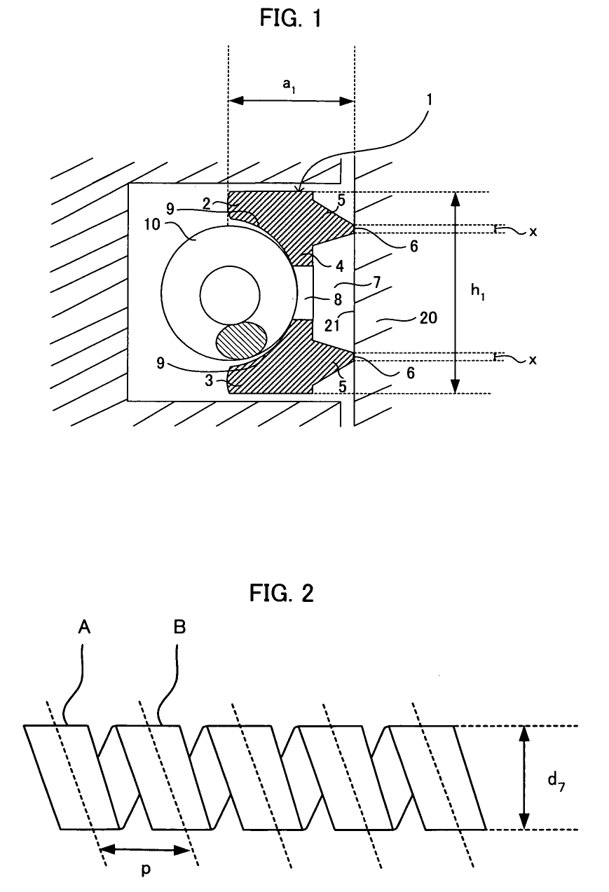

FIG. 1 is a schematic sectional view showing one example of the combined oil ring of this embodiment. An oil ring 1 comprises two rails 2 and 3 which are connected to each other through a columnar web 4. The oil ring 1 has a substantially I-shaped cross section, and the two rails 2 and 3 are shaped and placed symmetrically.

The oil ring 1 includes sliding projections 5. On a tip of the sliding projections 5, a sliding surface 6 which slides on an inner wall 21 of a cylinder bore 20. An outer peripheral groove 7 is formed by connecting the rails 2 and 3 with each other through the web 4. Lubricating oil scraped off by the sliding surface 6 from a cylinder inner wall 21 is received in the outer peripheral groove 7. The lubricating oil received in the outer peripheral groove 7 passes through oil holes 8 which are provided in a plurality in the web 4, and flows toward the inner peripheral side of the oil ring 1.

In the oil ring 1 having the above structure, the rails 2 and 3 are connected to each other through the web 4 to form an inner peripheral groove 9 on the inner peripheral side. A coil expander 10 which urges the oil ring 1 radially outward of the oil ring 1 to press the oil ring against the cylinder inner wall 21 is placed in the inner peripheral groove 9.

In this embodiment, the coil expander 10 is formed of shape memory alloy and the anomaly wire having a rectangular cross sectional shape is wound in a form of a coil. With this, even when the coil expander having such a coil diameter that coil expander can be placed in the inner peripheral groove of the thin oil ring, sufficient tension can be obtained. Thus, a combined oil ring having excellent oil scraping function and oil control function can be obtained.

Although FIG. 1 shows, as one example of the combined oil ring of this embodiment, an example of a two-piece oil ring having the oil ring 1 and the coil expander 10, the combined oil ring of this embodiment is not limited to the two-piece oil ring shown in FIG. 1, and the combined oil ring may be a three-piece oil ring or a four-piece oil ring.

Hereinafter, the coil expander and the oil ring of the combined oil ring of this embodiment will be explained in detail.

1. Coil Expander

In the combined oil ring, the coil expander is placed in the inner peripheral groove, formed on the inner peripheral side, which is formed by connecting the rails of the oil ring to each other through the web. The coil expander is provided so as to reliably exhibit the oil scraping function and the like of the oil ring by pressing and urging the oil ring radially outward.

In this embodiment, the coil expander is formed by using the wire material comprising shape memory alloy, and the wire material is formed into an anomaly wire having a rectangular cross sectional shape.

Generally, the shape memory alloy is in a martensitic state (M phase) at the room temperature and is in an austenitic state (A phase) at the high temperature. A transformation from the martensitic state to the austenitic state is called a reversed martensitic transformation, and a transformation from the austenitic state to the martensitic state is called a martensitic transformation. The temperature at which such transformation is took place is called martensitic transformation temperature. The martensitic transformation temperature has a certain temperature width, and this temperature width is obtained from peaks of endothermic reaction and exothermic reaction by means of differential thermal analysis.

The shape memory alloy has a phenomenon, i.e., a shape memorizing effect in which after deforming the shape memory alloy by a load and removing the load at a temperature lower than the martensitic transformation temperature, the shape of the shape memory alloy returns to its original shape by heating the shape memory alloy to a temperature higher than a certain value (e.g., in the case of Ti—Ni-based material, martensitic transformation temperature −10° C. to 100° C.) . In such a shape memorizing effect, the temperature at which the alloy returns to its previously memorized shape is a martensitic transformation temperature.

In the present embodiment, it is preferable that, by utilizing such shape memorizing effect, the coil expander is treated such that it expands in its longitudinal direction when the temperature of the coil expander itself becomes higher than the martensitic transformation temperature. First, at starting of the engine, the temperature of the lubricating oil and the engine temperature are gradually increased, and as compared with a case in which certain time has passed after the starting of the engine and the engine is sufficiently driven, the temperature of the lubricating oil and the engine temperature are low, and the viscosity of lubricating oil is high. This temperature at that time is lower than the martensitic transformation temperature of this embodiment. Even at the starting of the engine, a normal coil expander exhibits about the same tension as that when the engine is sufficiently driven. Thus, at the starting of the engine, the effect of the oil ring is too strong and this deteriorates the starting performance of the engine. In this embodiment, however, since the engine temperature at the starting of the engine is lower than the martensitic transformation temperature, the coil expander is not extended in its longitudinal direction, and sufficient tension is not exhibited. Therefore, the surface pressure of the oil ring is not increased in such a degree that the starting performance is deteriorated and thus, there is an effect that the starting performance of the engine is enhanced.

On the other hand, when the engine is sufficiently driven, somewhat high surface pressure is required to obtain the oil scraping function and the oil control function of the oil ring, but if the temperature of the coil expander itself exceeds the martensitic transformation temperature, as the engine temperature increases, the coil expander extends in its longitudinal direction. By this, a reaction force as a spring is increased so that the tension can be increased. As a result, the oil ring can obtain the surface pressure of such a degree that the function of the oil ring can sufficiently be exhibited. For this reason, in this embodiment, it is preferable that, if the temperature of the coil expander itself becomes higher than the martensitic transformation temperature, the coil expander is treated such that it is extended in its longitudinal direction.

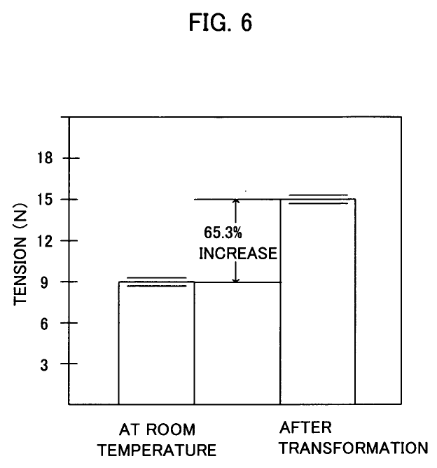

An experiment was actually conducted to research the increase of the tension of the coil expander after the martensitic transformation. FIG. 6 shows a result of the experiment. In the experiment, Ni—Ti based (50 to 51 atom % Ni) shape memory alloy was used, the coil diameter of the coil expander was 1.1 mm, a ratio of the thickness and the width of the cross sectional shape of the anomaly wire was 1:3 (thickness was 0.3 mm, width was 0.9 mm), and the width (h1) of the oil ring (nominal diameter was φ79 mm) in the axial direction was 1.5 mm.

As apparent from the result shown in FIG. 6, the tension of the coil expander after the martensitic transformation is increased by about 65.3% as compared with the tension of the coil expander at the room temperature, the engine temperature is increased, and when the temperature of the coil expander itself becomes higher than the martensitic transformation temperature, sufficient tension can be obtained.

Moreover, the tension of the coil expander before the martensitic transformation in the present embodiment is preferably in a range of 1N to 20N, more preferably in a range of 1N to 10N, for example in the case of a coil expander used for the h1 size of 2.0 mm or smaller. Before the martensitic transformation, the engine is in the warm-up state, and the engine temperature is gradually increased. Therefore, if the coil expander has the tension in the above range, the starting performance of the engine can be enhanced.

Further, the tension after the martensitic transformation is not particularly limited only if the functions of the oil ring is not deteriorated. However, if the coil expander is used for the h1 size of 2.0 mm or smaller for example, it is preferable that the tension is in a range of 3N to 30N, more preferably in a range of 3N to 20N. Generally, it is effective to reduce the surface pressure of the oil ring to reduce the friction, but the friction can be reduced by adjusting the tension of the coil expander after the martensitic transformation in the above range, and the fuel economy can be enhanced.

Materials to form the coil expander of the embodiment are not particularly limited only if the material is the shape memory alloy. More specifically, examples of the materials are Ti—Ni-based material, Cu—Zn—Al-based material, Fe—Mn—Si-based material and the like. In the present embodiment, Ti—Ni-based material is preferable, and Ti—Ni is most preferable. This is because that Ti—Ni is excellent in terms of strength, fatigue resistance, repeating characteristics, and corrosion resistance.

When shape memory alloy formed of Ti—Ni is used, it is preferable that the ratio thereof is Ti-50 atom % Ni to Ti-51 atom % Ni.

It is preferable that the martensitic transformation temperature in the case of Ti—Ni-based material and Fe—Mn—Si-based material is in a range of −10° C. to 200° C. For example, in the case of Ti‘Ni-based material, it is preferable that the martensitic transformation temperature is in a range of −10° C. to 100° C. and more preferably in a range of 30° C. to 100° C. The martensitic transformation temperature can be changed by composition of the shape memory alloy and the thermal treatment and the like when the shape memory alloy is produced, but if the martensitic transformation temperature is adjusted in the above range, martensitic transformation is generated in the coil expander, at a temperature where the surface pressure to an extent such that the oil ring function can sufficiently be exhibited, is required, and sufficient tension can be obtained.

The coil expander of the embodiment is formed by using anomaly wire having a rectangular cross sectional shape. With this, even if the coil diameter of the coil expander is reduced, to such a degree that the coil expander can be installed in the inner peripheral groove of the thin oil ring, sufficient tension can be exhibited, and a problem of tension shortage in the coil expander formed of shape memory alloy can be solved.

The term “rectangular” includes squares and rectangles. A shape which can be grasped as a rectangular, as a whole, is also included in the term “rectangular”, and even a shape whose angle portion is slightly round due to problems of working precision and the like, is also included in the term “rectangular”.

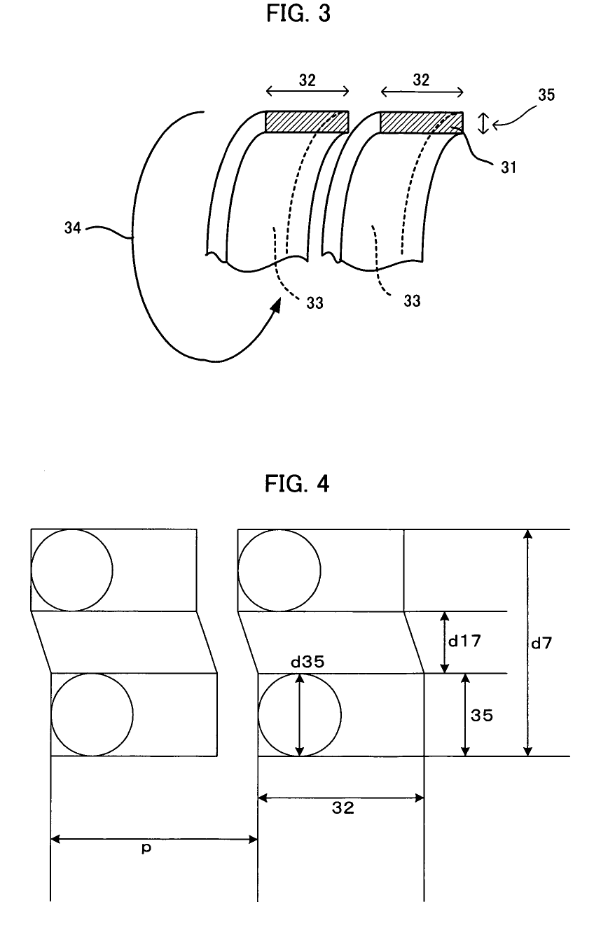

More specifically, in the anomaly wire forming the coil expander, it is preferable that the ratio of the thickness (thickness 35 in FIG. 3) and the width (width 32 in FIG. 3) of the cross sectional shape is in a range of 1:1 to 1:4, more preferably in a range of 1:2 to 1:3.5, and more preferably in a range of 1:2 to 1:3. If the ratio of the width is greater than the above range, this is not preferable because it is necessary to increase the pitch, and it becomes difficult to bend it at predetermined curvature. If the ratio of width is smaller than the above range, it is not preferable because when it is wound at predetermined pitch, since the gap formed between the adjacent wire materials is increased and thus, the spring constant becomes smaller so that the sufficient tension cannot be obtained in some cases.

In a coil expander having h1 size of 2 mm of smaller, the thickness of the anomaly wire is preferably in a range of 0.2 mm to 0.5 mm, and more preferably in a range of 0.3 mm to 0.4 mm. If the thickness is smaller than the above range, it is not preferable because the reaction force as a spring is weak, and sufficient tension cannot be obtained. On the other hand, if the thickness is greater than the above range, it is not preferable because the coil expander of a predetermined coil diameter cannot be obtained. The width is preferably in a range of 0.2 mm to 2.0 mm, and more preferably in a range of 0.45 mm to 1.0 mm.

Here, the term “pitch” means a length, when the wire material is wound in a form of a coil, from a center of the wire material to the center of the adjacent wire material in one rotation of the wire material. More specifically, in one rotation from A to B as shown in FIG. 2, a gap p from the center of the wire material at the position A to the center of the wire material at the position B. Such a pitch is determined substantially in predetermined range in accordance with the coil diameter of the coil expander. The term “coil diameter” of the coil expander means an outermost length of length in the radial direction of the coil expander. More specifically, the coil diameter d7 is shown in FIG. 2. In the case of a coil expander having h1 size of 2 mm or smaller, it is preferable that the coil diameter is in a range of 0.3 mm to 1.8 mm, and more preferably in a range of 0.4 mm to 1.4 mm. This is because that if the coil diameter is in the above range, the coil expander can match even to the thin oil ring. When the coil diameter of the coil expander is in the above range, the pitch, for example in the coil expander having h1 size of 2 mm or smaller, is roughly prescribed in a range of 0.3 mm to 1.8 mm, more preferably in a range of 0.3 to 1.4 mm. The coil expander of the embodiment is formed by winding the anomaly wire in the form of a coil at the pitch in the above range, and it is preferable that the pitch is constant. The term “predetermined pitch” in this specification means that the pitch is in the above range.

As the winding manner for forming the anomaly wire into the coil expander which is coiled, it is preferable to wind the anomaly wire such that the long side of the cross sectional shape of the anomaly wire forms the coil diameter of the coil expander. By such winding manner, the coil diameter of the coil expander can be minimized, and the reaction force as a spring can sufficiently be exhibited so that the desired tension can be obtained.

This winding manner will be explained concretely using the drawings. FIG. 3 is a schematic sectional view when the coil expander of this embodiment is cut in its longitudinal direction. As shown in FIG. 3, in the cross sectional shape 31 of the anomaly wire forming the coil expander, it is wound such that a surface 33 having the width 32 and the thickness 35 forms the diameter direction shown with the arrow 34. By this winding manner, in the anomaly wire having the rectangular cross sectional shape, the coil diameter of the coil expander is minimized. Even in the inner peripheral groove of the thin oil ring having limitation in size, the coil expander can be placed and desired tension can sufficiently be obtained. A closed gap may be any of tight winding and winding up.

2. Oil Ring

Next, the oil ring will be explained. Generally, the oil ring is provided for scraping off excessive lubricating oil on the cylinder inner wall and for suppressing the consumption amount of lubricating oil to an appropriate level.

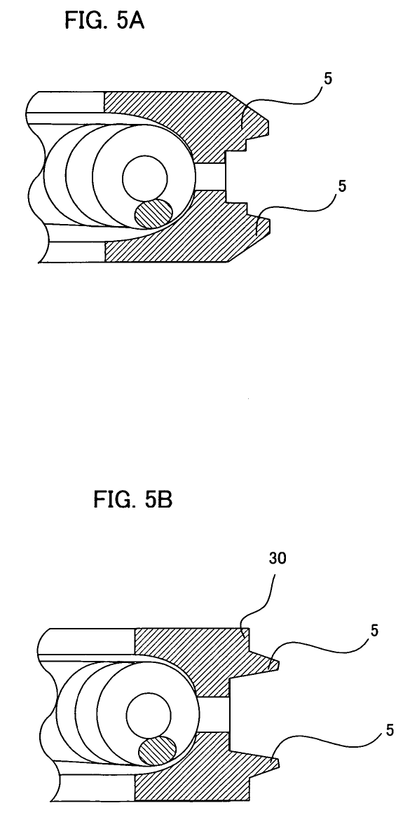

The oil ring of this embodiment is not particularly limited only if the oil ring has a substantially I-shaped cross section formed by connecting the two rails to each other through the columnar portion and the above-described coil expander can be placed in the inner peripheral groove formed on the side of the inner periphery by connecting the two rails. More specifically, an oil ring which is generally used in a combined oil ring can be used. Examples of the overall shape of the oil ring are: a shape in which the cross sectional shape of the sliding projection 5 is formed to be a trapezoid, as shown in FIG. 1; a shape in which the inner side portion of the sliding projection 5 is formed to be a stepwise-shape, as shown in FIG. 5(A); and a shape in which the sliding projection 5 is provided on the inner side in the axial direction of the oil ring 1 and a portion which is generally called a shoulder 30 is provided on the outer side in the axial direction, as shown in FIG. 5(B).

In such an oil ring, it is preferable that the thin oil ring is used in this embodiment. This is because that the thin oil ring has excellent following capability. The above-described coil expander can match the thin oil ring having limitation in size, and sufficient tension can be exhibited. Thus, it is possible to make the best possible use of the effect of the embodiment.

Here, the term “thin” means that the width of the oil ring in the axial direction is reduced. Here, the width of the oil ring in the axial direction means a width of the oil ring in the axial direction of the oil ring from the upper surface of the upper rail to the lower surface of the lower rail in the upper and lower rails constituting the oil ring. More specifically, the width means a width h1 in the axial direction of the oil ring from the upper surface of the upper rail 2 to the lower surface of the lower rail 3 as shown in FIG. 1.

The width of the oil ring in the axial direction is preferably 3 mm or smaller and more preferably in a range of 1.0 mm to 2 mm. If the width, in the axial direction of the oil ring, of the thin oil ring is in the above range, the following capability can be enhanced, the piston ring can be reduced in weight, and the consumption of lubricating oil can be reduced. This is because, in the case of the thin oil ring, when the piston is reciprocated at high speed and the oil ring is inclined, the distance from the cylinder inner wall can be reduced and thus, adverse influence due to such inconvenience is small and as a result, the following capability can be enhanced.

In this embodiment, materials for forming the oil ring are not particularly limited as long as the materials have appropriate toughness, and have no fear to be deformed by the tension from the coil expander, specifically, steel material which is conventionally used for oil rings. Among the above, martensitic stainless steel (SUS440, SUS410), 10Cr, 8Cr, alloy tool steel (SKD material), SKD61, SWOSC-V, SWRH or equivalent thereof and the like can be used preferably.

3. Combined Oil Ring

The combined oil ring of this embodiment comprises the above-described coil expander placed in the inner peripheral groove formed on the inner periphery side of the columnar portion of the oil ring. The coil expander is formed of shape memory alloy, and the coil expander is formed of anomaly wire having the rectangular cross sectional shape.

In this embodiment, the coil expander is formed of shape memory alloy and formed by using the anomaly wire having the rectangular cross sectional shape. Therefore, desired tension can be obtained without increasing the coil diameter of the coil expander. Thus, the coil expander matches even to the thin oil ring having size limitation. Therefore, the combined oil ring can exhibit excellent oil scraping function and oil control function. Since the shape memory alloy is used, the friction can be reduced even when the oil viscosity is high at the starting of the engine.

The tension of the combined oil ring of this invention is not particularly limited as long as it can be pressed preferably to the cylinder inner wall. Specifically, it is preferable that the tension ratio, obtained by dividing the tension of the combined oil ring by the bore diameter, is 0.5 N/mm or smaller, more preferably 0.2 N/mm or smaller. The combined oil ring having the tension in this range is generally called a low tension combined oil ring. With this low tension combined oil ring, the friction can be reduced.

### B. Second Embodiment

Next, a combined oil ring of a second embodiment of the present invention will be explained.

The combined oil ring of this embodiment comprises: an oil ring formed into cross-section substantially of an I-shape that two rails are connected at a columnar portion thereof; and a coil expander, which is placed in an inner peripheral groove formed on the inner side of a periphery of the columnar portion connecting the two rails of the oil ring, and which presses the oil ring radially outward, wherein a width of the oil ring in an axial direction is in a range of 0.3 mm to 3 mm, the coil expander is formed of a shape memory alloy, and the coil expander is treated such that if a temperature of the coil expander itself is higher than a martensitic transformation temperature of the shape memory alloy, the coil expander extends in its longitudinal direction.

In this embodiment, the combined oil ring is obtained by combining the thin oil ring in the above range and the coil expander comprising the shape memory alloy treated as mentioned above. Thus, the following capability can further be enhanced. This is because the coil expander of this embodiment is treated such that if the temperature of the coil expander exceeds the martensitic transformation temperature, the coil expander extends in its longitudinal direction. Thus, the tension exhibited by the coil expander can be higher, when the engine is sufficiently driven, than the tension at starting of the engine. Therefore, the following capability of the oil ring can be enhanced. Thus, because of effects of both the thin oil ring and the coil expander formed of shape memory alloy, the combined oil ring can exhibit excellent following capability. Further, the friction can be reduced even when the oil viscosity is high at the starting of the engine.

The combined oil ring of this embodiment having such merits will be explained referring to the drawings.

FIG. 1 is a schematic sectional view showing one example of the combined oil ring of this embodiment. The outline structure of the combined oil ring of this embodiment is the same as that of the first embodiment and thus, explanation thereof will be not repeated.

The oil ring of this embodiment is formed such that the width h1 of the oil ring in the axial direction is in the above range. In the embodiment, the coil expander 10 is formed of shape memory alloy, and is treated such that if the temperature of the coil expander itself becomes higher than the martensitic transformation temperature, the coil expander is extended in its longitudinal direction. With this, since the tension of the coil expander is increased after the martensitic transformation, the following capability of the oil ring can be enhanced. Thus, because of effects of both the thin oil ring and the coil expander formed of shape memory alloy, the combined oil ring can exhibit excellent following capability.

Although FIG. 1 shows, as one example of the combined oil ring of this embodiment, two-piece oil ring having the oil ring land the coil expander 10, the combined oil ring of this embodiment is not limited to the two-piece oil ring shown in FIG. 1, and the combined oil ring may be a three-piece oil ring or a four-piece oil ring.

Hereinafter, the oil ring and the coil expander of such combined oil ring of the present embodiment will be explained for each.

1. Oil Ring

First, the oil ring will be explained. Generally, the oil ring is provided for scraping off excessive lubricating oil on the cylinder inner wall and for suppressing the consumption of lubricating oil to an appropriate level.

The oil ring of this embodiment has a substantially I-shaped cross section formed by connecting the two rails to each other through the columnar portion and a later-described coil expander can be placed in the inner peripheral groove formed on the inner peripheral side of the columnar portion which connects the two rails to each other. A width thereof in the axial direction is in a predetermined range.

Here, the width of the oil ring in the axial direction means a width of the oil ring in the axial direction of the oil ring from the upper surface of the upper rail to the lower surface of the lower rail in the upper and lower rails constituting the oil ring. More specifically, the width means a width h1 in the axial direction of the oil ring from the upper surface of the upper rail 2 to the lower surface of the lower rail 3 as shown in FIG. 1.

The width of the oil ring in the axial direction is preferably in a range of 0.3 mm to 3 mm, and more preferably in a range of 1.0 mm to 3.0 mm, and particularly preferably in a range of 1.0 mm to 2.0 mm. The oil ring having the width in the axial direction in the above range is a thin oil ring, and is effective for enhancing the following capability. Thus, this enhances the oil ring function and the consumption of lubricating oil can be reduced. Further, the weight of the piston ring can be reduced.

The reason why the following capability is enhanced by reducing the width of the oil ring in the axial direction will be explained below using an equation showing the following capability.

Here, Pk (following capability coefficient) showing the degree of the following capability can be obtained by the following equation:

As the Pk value is increased, the following capability is enhanced more, and if the Pk value is reduced, the following capability is deteriorated.
Pk=3×Ft×d12/(E×h1×a13×K)

Wherein Pk is following capability coefficient, Ft is tension, d1 is a bore diameter, E is Young's modulus, h1 is width of the oil ring in the axial direction, a1 is width of the oil ring in the radial direction, and K is shape coefficient.

Here, the term “bore diameter” means a diameter of a cylinder bore on which the oil ring slides. The width of the oil ring in the radial direction means a thickness of the oil ring in its radial direction, and is obtained by a difference between the outermost diameter and the innermost diameter of the oil ring. More specifically, the width of the oil ring in the radial direction means a1 shown in FIG. 1.

Here, if d1, E and K are constants and a is equal to 3d12/(E×K), the above equation can be rewritten as follows:
Pk=Ft/(h1×a13)×α

It can be found from the above equation that if Ft is increased, the Pk value is also increased, or if h1 or a1 is reduced, the Pk value is increased.

Here, a1 and h1 are generally proportional to each other, and if a predetermined numerical value is defined as s, a1=h1×s can be obtained. From this, the above equation can be converted as follows:
Pk=Ft/(h14×s3)×α

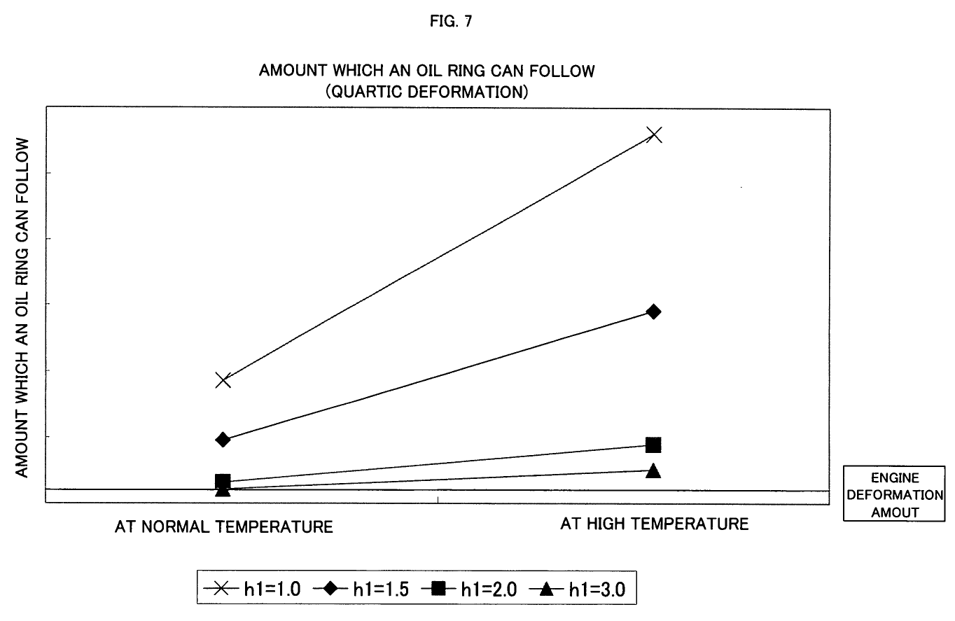

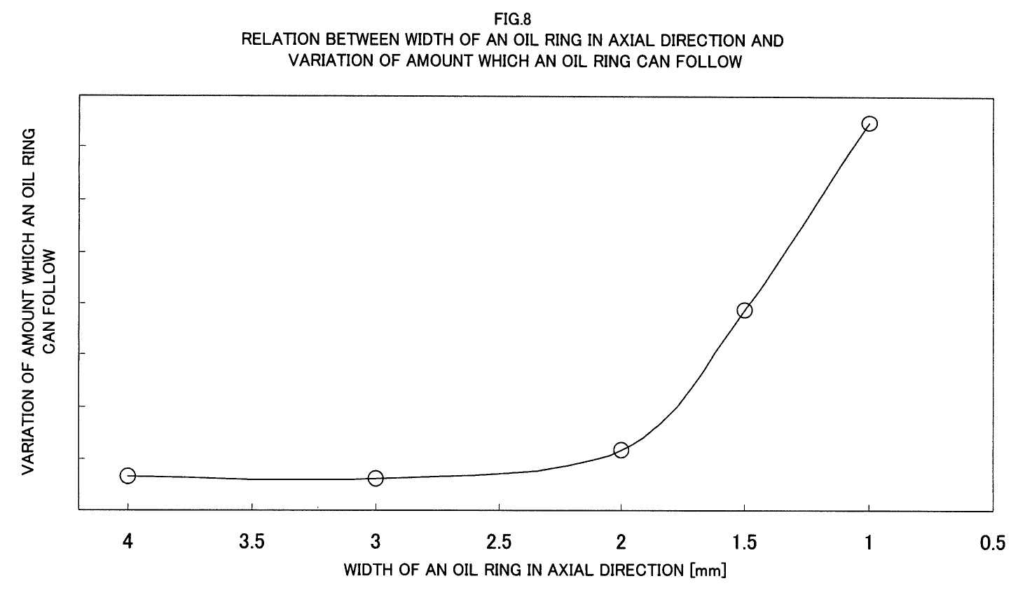

It can be found that h1 size, i.e., fourth power of the width of the oil ring in the axial direction and the following capability coefficient are inversely proportional to each other. From the room temperature data shown in FIG. 7, when h1=1.5 or further, h1=1.0, if the oil ring is thinned, the following capability for bore is enhanced, as compared with a case in which h1=3.

From the above description, it is apparent from the above equation that the variation of the width of the oil ring in the axial direction largely influences the following capability. Therefore, the reducing of the width of the oil ring in the axial direction is effective for enhancing the following capability.

In the combined oil ring of this embodiment, an experiment was carried out to determine how much degree the oil ring can follow with respect to the variation amount of the cylinder bore. FIG. 7 shows a result of the experiment at high temperature (after transformation). In the experiment, the widths h1 of the oil ring in the axial direction were 3.0 mm, 2.0 mm, 1.5 mm and 1.0 mm. The temperature condition was at the room temperature and at the high temperature. At the high temperature, in the coil expander of this embodiment, martensitic transformation, in which the coil expander extends in its longitudinal direction, is generated.

As apparent from the result shown in FIG. 7, it can be found that as the width h1 of the oil ring in the axial direction is reduced, the amount which the oil ring can follow is increased. In this embodiment, the below-described coil expander is formed of shape memory alloy, and the coil expander is treated such that if the temperature of the coil expander exceeds the martensitic transformation temperature of the shape memory alloy, the coil expander extends in its longitudinal direction. Therefore, at the high temperature, the following capability is enhanced by the shape memorizing effect. Particularly, when size of h1 is 3 mm, the amount which the oil ring can follow is smaller than the engine deformation amount at the room temperature. However, at the high temperature, since the amount which the oil ring can follow is higher than the engine deformation amount, it is suggested that sufficient following capability can be obtained by the effects of both of the thin oil ring and the coil expander which is treated as described above.

FIG. 8 is a graph showing the variation at room temperature and at high temperature per width of the oil ring in the axial direction based on the result of the amount which an oil ring can follow shown in FIG. 7. From the result shown in FIG. 8, it can be found that the following capability is largely enhanced after the martensitic transformation of the coil expander if the width of the oil ring in the axial direction becomes 2.0 mm or less, since the inclination is largely varied when the width of the oil ring in the axial direction is about 2.0 mm.

Next, the sliding surface width of the oil ring in the axial direction will be explained. Here, the sliding surface width means a width x of the sliding surface 6 which comes into contact with the cylinder inner wall 21 as shown in FIG. 1, and the width x is in parallel direction to the axial direction of the sliding surface 6. The sliding surface width is a total value of the widths of both of the two rails. It is preferable that the sliding surface width is in a range of 0.1 mm to 1 mm, more preferably in a range of 0.1 mm to 0.5 mm. This is because if the sliding surface width is in the above range, it can sufficiently be matched to the thin oil ring.

The overall shape of the oil ring of this embodiment is not particularly limited as long as the oil ring is formed into cross-section substantially of an I-shape that two rails are connected a columnar portion thereof, and the coil expander can be installed in the inner peripheral groove formed on the inner periphery side by connecting the two rails to each other. Examples of the overall shape of the oil ring are: a shape in which the cross sectional shape of the sliding projection 5 is formed to be a trapezoid, as shown in FIG. 1; a shape in which the inner side portion of the sliding projection 5 is formed to be a stepwise-shape, as shown in FIG. 5(A); and a shape in which the sliding projection 5 is provided on the inner side in the axial direction of the oil ring 1 and a portion which is generally called a shoulder 30 is provided on the outer side in the axial direction, as shown in FIG. 5(B).

Since the material of the oil ring in this embodiment is the same as that of the first embodiment, explanation thereof is not repeated.

2. Coil Expander

Next, the coil expander of this embodiment will be explained.

In the combined oil ring, the coil expander is placed in the inner peripheral groove which is formed on the inner peripheral side by connecting the rails of the oil ring to each other through the web. The coil expander is provided so that the oil scraping function of the oil ring can be reliably exhibited by pressing the oil ring radially outward.

The coil expander of this embodiment is formed by using wire material formed of shape memory alloy, and is treated such that the coil expander extends in its longitudinal direction when the temperature of the coil expander itself becomes higher than the martensitic transformation temperature of the shape memory alloy.

In this embodiment, the shape memorizing effect is used, and for example, in the state in which the engine is sufficiently driven after the warm up, the engine temperature is higher than the martensitic transformation temperature in this embodiment. Thus, the martensitic transformation is generated in the coil expander, and the tension can be increased as compared with a case at the starting of the engine. With this, the surface pressure of the oil ring is also increased. Thus, the following capability can further be enhanced after the martensitic transformation of the coil expander. Therefore, the sufficient following capability can be exhibited by both functions of the oil ring and the coil expander, and the combined oil ring can exhibit excellent oil ring function.

Since the shape memory alloy is used, the starting performance of the engine is also enhanced. This is because of the following reason:

First, at starting of the engine, the temperature of the lubricating oil and the engine temperature are gradually increased, and as compared with a case in which certain time is elapsed after the starting of the engine and the engine is sufficiently driven, the temperature of the lubricating oil and the engine temperature are low, and the viscosity of lubricating oil is high. This temperature at that time is lower than the martensitic transformation temperature in this embodiment. A normal coil expander exhibits about the same tension as that when the engine is sufficiently driven even at the starting of the engine. Thus, at the-starting of the engine, the function of the oil ring is too strong so that the starting performance of the engine is deteriorated. In this embodiment, however, since the engine temperature at the starting of the engine is lower than the martensitic transformation temperature, the coil expander is not extended in its longitudinal direction, and sufficient tension is not exhibited. Therefore, the surface pressure of the oil ring is not increased in such a degree that the starting performance is deteriorated. Thus, there is an effect that the friction can be reduced at the starting of the engine. The tension of the coil expander, the tension after the martensitic transformation and material to form the coil expander in this embodiment are the same as those of the “1. Coil expander” in the first embodiment, the same explanation will be not repeated.

It is preferable that the cross sectional shape of the coil expander is formed of anomaly wire. With this, even if the coil diameter of the coil expander is reduced to such a degree that the coil expander can be placed in the inner peripheral groove of the thin oil ring, sufficient tension can be exhibited. The reason thereof is as described in the “A. First Embodiment”, referring to FIG. 4.

Here, the term “anomaly wire” does not include a round wire which has a circular cross sectional shape. The anomaly wire includes a shape whose angle portion is slightly round due to processing precision only if the overall shape is not round. Concretely, examples of the anomaly wire are wire materials which have square and rectangular cross sectional shapes.

In the anomaly wire forming the coil expander, the ratio of the thickness and the width of the cross sectional shape, the thickness of the anomaly wire, the pitch and the winding manner are the same as those of the first embodiment, and thus, explanation thereof will be not repeated.

3. Combined Oil Ring

The combined oil ring of this embodiment comprises the above-described coil expander placed in the inner peripheral groove formed on the inner periphery side of the columnar portion of the oil ring, wherein a width of the oil ring in an axial direction is in a range of 0.3 mm to 3 mm, the coil expander is formed of a shape memory alloy, and the coil expander is treated such that if a temperature of the coil expander itself is higher than a martensitic transformation temperature of the shape memory alloy, the coil expander extends in its longitudinal direction.

In this embodiment, with the thin oil ring in the above range and the coil expander formed of shape memory alloy treated as described above, the following capability can be enhanced. Since the coil expander of the embodiment is treated such that if the temperature of the coil expander itself exceeds the martensitic transformation temperature of the shape memory alloy, the coil expander extends in its longitudinal direction. Thus, if the engine is sufficiently driven, the tension of the coil expander can be increased as compared with the case at the starting of the engine. Therefore, the following capability of the oil ring can be enhanced. Thus, from the both function of the thin oil ring and the function of the coil expander formed of shape memory alloy, the combined oil ring can exhibit excellent following capability.

The tension of the combined oil ring of this embodiment is the same as that of the oil ring of the first embodiment.

The present invention is not limited to the above embodiments. The embodiments are described for illustrative purpose only, those having substantially the same technical idea and those exhibiting the same functions and effects as described in claims of the present invention are included in the technical scope of the present invention.

### EXAMPLE

Next, the present invention will be explained in more detail by way of an example. Ti—Ni-based alloy (50 to 51 atom % Ni alloy) was used as the shape memory alloy.

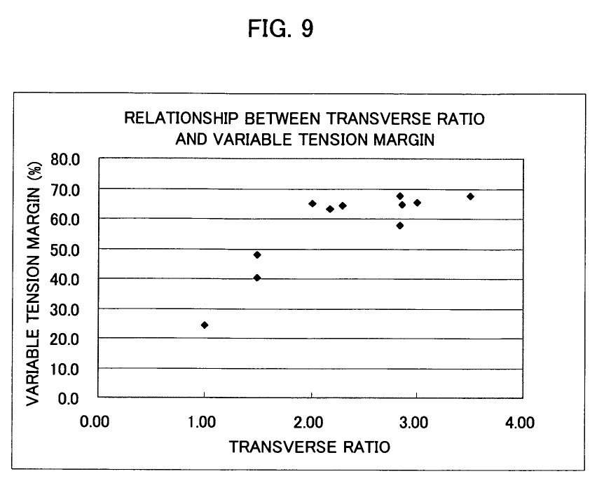

The variation of variable tension margin with respect to the ratio (aspect ratio) of the thickness and the width of the cross sectional shape of the anomaly wire of the coil expander was examined. FIG. 9 shows a result which is actually obtained by an experiment. In the experiment, the coil diameter (size d7 in FIG. 2) of the coil expander was changed in a range of 1.1 mm to 1.5 mm, the pitch (p in FIG. 2) was changed in a range of 0.7 mm to 1.4 mm, the thickness of the cross sectional shape of the anomaly wire (35 in FIG. 3) was changed in a range of 0.3 mm to 0.4 mm, and the width (32 in FIG. 3) was changed in a range of 0.45 mm to 1.00 mm. As spring distortions, the thickness of the cross sectional shape of the anomaly wire (35 in FIG. 3), the coil diameter of the coil expander (d7 in FIG. 2) and shrinkage margin (expander free state—a state in which the coil expander is set to a ring) were set depending on the ring size and tension. Spring distortions, nominal diameters (outer diameter sizes), widths of the oil ring in the axial direction (h1 in FIG. 1) and variable tension margins of sample expanders of the various transverse ratio used in the experiment are shown in Table 1. The tension of each test sample obtained after martensitic transformation was calculated by the following equation:
(tension after variation−tension before variation)/tension before variation×100=variable tension margin (%)

TABLE 1

| | | Nominal | | Variable |
|---|---|---|---|---|
| Size ratio | Spring | diameter | h1 size | tension |
| Thickness:Width | distortion | (mm) | (mm) | margin (%) |
| 1:1.00 | 0.257% | 79.0 | 1.5 | 24.5 |
| 1:1.50 | 0.279% | 79.0 | 1.5 | 40.5 |
| 1:1.50 | 0.477% | 79.0 | 1.5 | 48.0 |
| 1:2.00 | 0.696% | 71.0 | 2.0 | 65.0 |
| 1:2.17 | 0.611% | 79.0 | 1.5 | 63.2 |
| 1:2.29 | 0.607% | 94.0 | 1.5 | 64.3 |
| 1:2.83 | 0.538% | 71.0 | 1.5 | 57.8 |
| 1:2.83 | 0.736% | 79.0 | 1.5 | 67.7 |
| 1:2.86 | 0.591% | 94.0 | 1.5 | 64.9 |
| 1:3.00 | 0.616% | 79.0 | 1.5 | 65.3 |
| 1:3.50 | 0.560% | 79.0 | 1.5 | 67.5 |

From the above result, if the size ratio of the coil expander is set in a range of 1:1 to 1:3.5, 20% or higher variable tension margin can be obtained. Particularly, by setting the size ratio in a range of 1:2 to 1:3.5, about 60% or higher variable tension margin was obtained. If the tension is set to such a value that oil consumption can be satisfied at high temperature (high rotation region), that is, after the martensitic transformation, the tension at the normal temperature can be set low by about 40% (100/1.6=0.625), and the friction can be reduced.

1-7. (canceled)

8. A combined oil ring comprising:
an oil ring formed into cross-section substantially of an I-shape that two rails are connected at a columnar portion thereof; and a coil expander, which is placed in an inner peripheral groove formed on the inner side of a periphery of the columnar portion connecting the two rails of the oil ring, and which presses the oil ring radially outward,
wherein the coil expander is formed of a shape memory alloy, and is formed of anomaly wire having rectangular cross sectional shape.

9. The combined oil ring according to claim 8, wherein the coil expander formed of the shape memory alloy is treated such that if a temperature of the coil expander itself is higher than a martensitic transformation temperature of the shape memory alloy, the coil expander extends in its longitudinal direction.

10. The combined oil ring according to claim 8, wherein a ratio of a thickness and a width of the cross sectional shape of the anomaly wire, which forms the coil expander, is in a range of 1:1 to 1:4.

11. The combined oil ring according to claim 9, wherein a ratio of a thickness and a width of the cross sectional shape of the anomaly wire, which forms the coil expander, is in a range of 1:1 to 1:4.

12. A combined oil ring comprising:
an oil ring formed into cross-section substantially of an I-shape that two rails are connected at a columnar portion thereof; and a coil expander, which is placed in an inner peripheral groove formed on the inner side of a periphery of the columnar portion connecting the two rails of the oil ring, and which presses the oil ring radially outward,
wherein a width of the oil ring in an axial direction is in a range of 0.3 mm to 3 mm,
the coil expander is formed of a shape memory alloy, and
the coil expander is treated such that if a temperature of the coil expander itself is higher than a martensitic transformation temperature of the shape memory alloy, the coil expander extends in its longitudinal direction.

13. The combined oil ring according to claim 12, wherein the width of the oil ring in the axial direction is in a range of 1.0 mm to 3.0 mm.

14. The combined oil ring according to claim 12, wherein the coil expander, which is formed of the shape memory alloy, is formed by using an anomaly wire.

15. The combined oil ring according to claim 13, wherein the coil expander, which is formed of the shape memory alloy, is formed by using an anomaly wire.

16. The combined oil ring according to claim 14, wherein a ratio of a thickness and a width of the cross sectional shape of the anomaly wire, which forms the coil expander, is in a range of 1:1 to 1:4.

17. The combined oil ring according to claim 15, wherein a ratio of a thickness and a width of the cross sectional shape of the anomaly wire, which forms the coil expander, is in a range of 1:1 to 1:4.
